(19) United States
(12) Patent Application Publication
(10) Pub. No.: US 2014/0327541 A1
(43) Pub. Date: Nov. 6, 2014

(54) SYSTEM AND METHOD FOR TRACKING FIREARMS

(71) Applicants: NASSER ANI, Holmdel, NJ (US); SAMAR SHAMI, Holmdel, NJ (US); FARES ANI, Holmdel, NJ (US)

(72) Inventors: NASSER ANI, Holmdel, NJ (US); SAMAR SHAMI, Holmdel, NJ (US); FARES ANI, Holmdel, NJ (US)

(21) Appl. No.: 13/887,418

(22) Filed: May 6, 2013

(51) Int. Cl. G01S 5/02; G01S 19/16; G06K 7/10

(52) U.S. Cl. CPC G01S 5/0294; G06K 7/10297; G01S 19/16
USPC 340/539.13

(57) ABSTRACT

In some embodiments, a system for tracking a firearm may include: a tracking station in communication with a network; a first tag coupled to a firearm, the first tag comprising a first tag identifier and a first Global Positioning System (GPS) transmitter, the first Global Positioning System (GPS) transmitter effective to communicate the location of the first tag to the tracking station over the network; a second tag, assigned to a user of the firearm or a storage location of the firearm, the second tag comprising a second tag identifier and a second GPS transmitter effective to communicate the location of the second tag to the tracking station over the network; and a database in communication with the tracking station, the database effective to associate the first tag identifier with the second tag identifier and to associate the location of the first tag with the location of the second tag.

### FIELD

Embodiments of the present invention generally relate to a system and method for tracking firearms.

### BACKGROUND

Conventionally utilized systems and methods for monitoring firearms typically include generating unique identifiers (e.g., a serial number or micro stamp) associated with the firearm and storing information relating to the unique identifiers in a database. However, the inventors have observed that such systems are passive and do not provide real time information with respect to the location of the firearm.

Therefore the inventors have provided embodiments of a system and method for tracking firearms.

### SUMMARY

Embodiments of a system and method for tracking firearms are provided herein. In some embodiments, a system for tracking a firearm may include: a tracking station in communication with a network; a first tag coupled to a firearm, the first tag comprising a first tag identifier and a first Global Positioning System (GPS) transmitter, the first Global Positioning System (GPS) transmitter effective to communicate a location of the first tag to the tracking station over the network; a second tag, assigned to a user of the firearm or a storage location of the firearm, the second tag comprising a second tag identifier and a second GPS transmitter effective to communicate a location of the second tag to the tracking station over the network; and a database in communication with the tracking station, the database effective to associate the first tag identifier with the second tag identifier and to associate the location of the first tag with the location of the second tag.

In some embodiments, a method for tracking firearms may include: coupling a first tag to a firearm, the first tag comprising a first tag identifier and a first Global Positioning System (GPS) transmitter, the first Global Positioning System (GPS) transmitter effective to communicate a location of the first tag; assigning a user of the firearm or a storage location of the firearm a second tag comprising a second tag identifier and a second GPS transmitter, the second GPS transmitter effective to communicate with a location of the second tag; determining the location of the first tag and the location of the second tag using the respective first Global Positioning System (GPS) transmitter and the second Global Positioning System (GPS) transmitter; and associating the first tag identifier with the second tag identifier and associating the location of the first tag with the location of the second tag in a database.

Other and further embodiments of the present invention are described below.

### BRIEF DESCRIPTION OF THE DRAWINGS

Embodiments of the present invention, briefly summarized above and discussed in greater detail below, can be understood by reference to the illustrative embodiments of the invention depicted in the appended drawings. It is to be noted, however, that the appended drawings illustrate only typical embodiments of this invention and are therefore not to be considered limiting of its scope, for the invention may admit to other equally effective embodiments.

FIG. 1 depicts a system for tracking firearms in accordance with some embodiments of the present invention.

FIGS. 2-2A depict a firearm capable of being tracked by a system for tracking firearms in accordance with some embodiments of the present invention.

FIG. 3 depicts a method for tracking a firearm in accordance with some embodiments of the present invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of a system and method for tracking firearms are provided herein. In at least some embodiments, the inventive system and method may advantageously provide location information with respect to a firearm and/or user of the firearm. In addition, the inventive system and method may further advantageously provide a database having location information of the firearm and its relative location to a user of the firearm or a storage location that is accessible by a firearm owner or law enforcement agent.

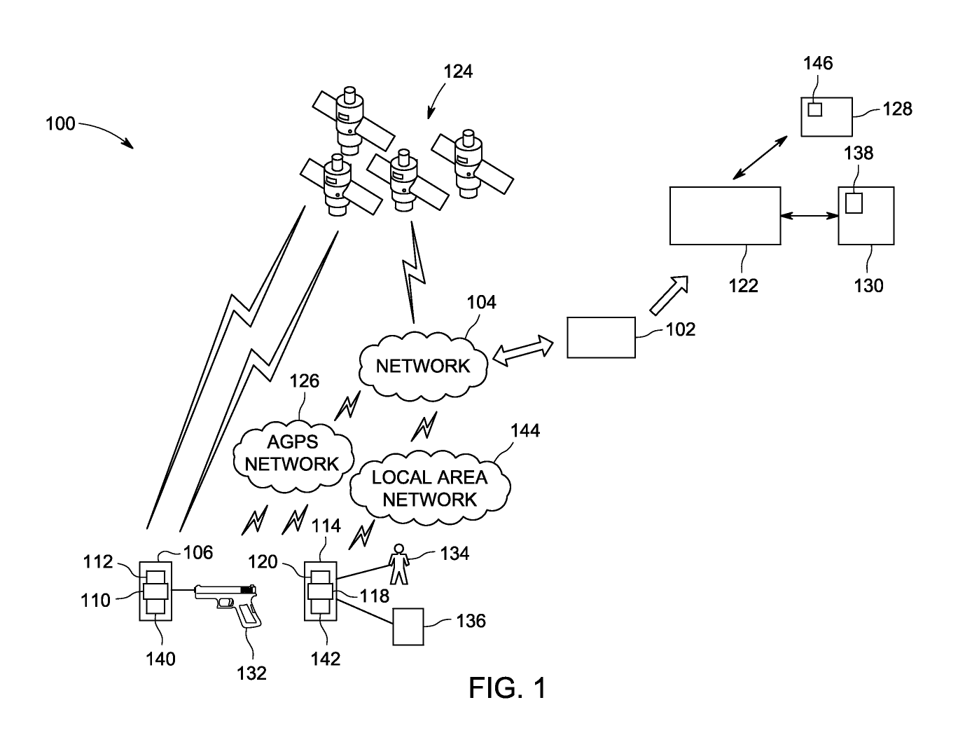

FIG. 1 depicts a system for tracking firearms in accordance with some embodiments of the present invention. In some embodiments, the system 100 generally comprises a first tag 106, a second tag 114, a tracking station 102 and a database 122 in communication with the tracking station 102.

The first tag 106 is coupled to a firearm 132 to be tracked and the second tag 114 is assigned to a user 134 of the firearm 132 or a storage location 136 of the firearm 132. The first tag 106 may be coupled to the firearm 132 in any manner suitable to provide a secure coupling of the first tag 106 to the firearm 132, for example, via an adhesive, a fastener, or the like. In some embodiments, the first tag 106 may be removably coupled to the firearm 132. Alternatively, in some embodiments, the first tag 106 may be permanently coupled to the firearm 132 during the manufacturing process of the firearm 132. For example, in some embodiments, the first tag 106 may be integrated into the firearm 132 during fabrication of one or more of the firearm 132 components.

The user 134 of the firearm 132 may be any person having temporary or permanent custody of the firearm 132, for example, a firearm owner, law enforcement officer, employee, client, customer, or the like. The storage location 136 of the firearm 132 may be any location suitable for firearm storage, for example, a gun rack, gun safe, law enforcement facility, secured room, or the like. In embodiments where the storage location 136 is movable (e.g., a gun safe, gun rack, or the like) the second tag 114 may be coupled to the storage location 136. In such embodiments, the second tag 114 may be coupled to the storage location 136 in any manner suitable to provide a secure coupling of the second tag 114 to the storage location 136, for example, via an adhesive, fastener, or the like.

For clarity, only the first tag 106 of the first tag 106 and the second tag 114 is described below. However, it is to be understood that the first tag 106 and the second tag 114 are substantially similar, having similar components, similar construction and operate in a similar manner.

In some embodiments, the first tag 106 comprises a first tag identifier 110 and a first global positioning system (GPS) transmitter 112 (second tag identifier 118 and second global positioning system (GPS) transmitter 120 shown for the second tag 114). The first tag 106 may comprise any components suitable to contain and transmit a unique identifier (e.g., the first tag identifier 110) and transmit a signal that would facilitate ascertaining the location of the first tag 106 via a global positioning network. In some embodiments, the first tag 106 may be a GPS enabled mobile phone, mobile device, personal digital assistant (PDA) or computer.

The first tag identifier 110 contains information unique to the first tag 106 to facilitate identifying the first tag 106 and/or differentiating the first tag 106 from other tags within the database 122. In addition, in some embodiments, the first tag identifier 110 may contain information relating to the firearm 132, for example, such as a serial number, manufacturer information, owner information, or the like. The first tag identifier 110 may be stored on the first tag 106 in any manner suitable to store and transmit such information, for example, such as stored in a digital memory of an integrated circuit or other electronic component of the first tag 106. In addition, in some embodiments, the first tag identifier 110 may include the information in a format that is readable via scanner, for example, a visible format such as bar code, quick response code, or the like, or a digital format such as digitally stored on a radio frequency identification (RFID) tag.

The first GPS transmitter 112 receives signals provided by a plurality of GPS satellites 124 to ascertain information regarding the location, speed and direction of the first tag 106 and transmits the information to the tracking station 102 via a network 104 (e.g., internet network, wireless cellular network, or the like). In some embodiments, the first GPS transmitter 112 may be configured to utilize an Assisted GPS (AGPS) network 126 to improve one or more of the accuracy, startup performance, or time to first fix (TTFF) of the first GPS transmitter 112.

In some embodiments, the first tag 106 may include an optional first local area transmitter 140 (second local area transmitter 142 shown for second tag 114), for example, such as a Bluetooth® transmitter, radio frequency identification (RFID) tag, wireless (e.g. Wi-Fi) adapter and/or antenna, or the like. When present, the first local area transmitter 140 may be configured to interact with a locally disposed network (e.g., a local area network 144) to facilitate local area tracking, for example, such as within a facility, such as a law enforcement agency, firearm range, firearm retailer, other commercial or non-commercial buildings, or the like. In such embodiments, the local area network 144 may communicate with the tracking station 102 to provide local area tracking information to the database 122.

In some embodiments, the tracking station 102 is in communication with the network 104 and receives information transmitted via the network 104 relating to the location of each of the first tag 106 and the second tag 114 and the information contained within the first tag identifier 110 and the second tag identifier 118. The information may be transmitted via any sufficient mechanism to provide the information from the first tag 106 and the second tag 114 via the network 104, for example, address headers within data packets can contain the address of specified tracking stations. Some exemplary network standards may include Transmission Control Protocol/Internet Protocol (TCP/IP), Internet Protocol (IP), Simple network Management Protocol (SNMP), Internetwork Packet eXchange (IPX), other communication protocols, combinations thereof, or the like.

In some embodiments, the network 104 may comprise one or more communication systems that connect computers by wire, cable, fiber optic and/or wireless link facilitated by various types of well-known network elements, such as hubs, switches, routers, and the like. The network 104 may include an Internet Protocol (IP) network, a public switched telephone network (PSTN), or other mobile communication networks, and may employ various well-known protocols to communicate information amongst the network resources.

In some embodiments, the database 122 is in communication with the tracking station 102 to receive the above described information from the tracking station 102. In some embodiments, the database 122 may sort the information such that the each of the firearm 132 and the user 134 of the firearm 132 and/or storage location 136 is associated with one another. For example, in some embodiments, the database 122 associates the first tag identifier 110 with the second tag identifier 118 and to associate the location of the first tag 106 with the location of the second tag 114. Associating the information in such a manner allows a user accessing the database 122 to identify a location of each of the firearm 132 (via the first tag 106) and the location of the associated user 134 of the firearm 132 or storage location 136. The database 122 may be in communication with the tracking station 102 via, for example, the network 104, such as described above with respect to the communication of the tracking station 102 with the network 104.

In some embodiments, the database 122 may be accessible via a communication device 128. In such embodiments, a user may be provided a unique access code (e.g., a password, pin number, or the like) to allow the user to access the information contained within the database relating to a specific first tag 106 and second tag 114. In some embodiments, the communication device 128 may be configured to receive a notification or alert when the first tag and/or second tag leaves a predetermined geographical area (e.g., as determined via a virtual perimeter such as a geo-fence, a local area network, such as the local area network 144 described above, or the like).

The communication device 128 may be any type of device suitable to communicate with the database 122, for example, such as a computer, laptop, mobile phone, tablet, personal digital assistant (PDA) or the like. The communication device 128 may be in communication with the database 122 via, for example, the network 104, such as described above with respect to the communication of the tracking station 102 with the network 104. In some embodiments, the communication device 128 may include a display 146 configured to display information obtained from the database 122 (e.g., relating to the location of the first tag and the location of the second tag).

In some embodiments, the system 100 may include a terminal (computer) 130 configured to provide information relating to the first tag 106 and the second tag 114 (e.g., the first tag identifier 110 and/or second tag identifier 118) to the database 122. For example, in some embodiments, the computer 130 may include a scanner 138 configured to read the first tag identifier 110 and/or second tag identifier 118 to provide information contained within the first tag identifier 110 and/or second tag identifier 118 to the database 122. When present, the scanner 138 may be utilized, for example, to record when the firearm 132 and/or user 134 of the firearm 132 enters or exits a facility.

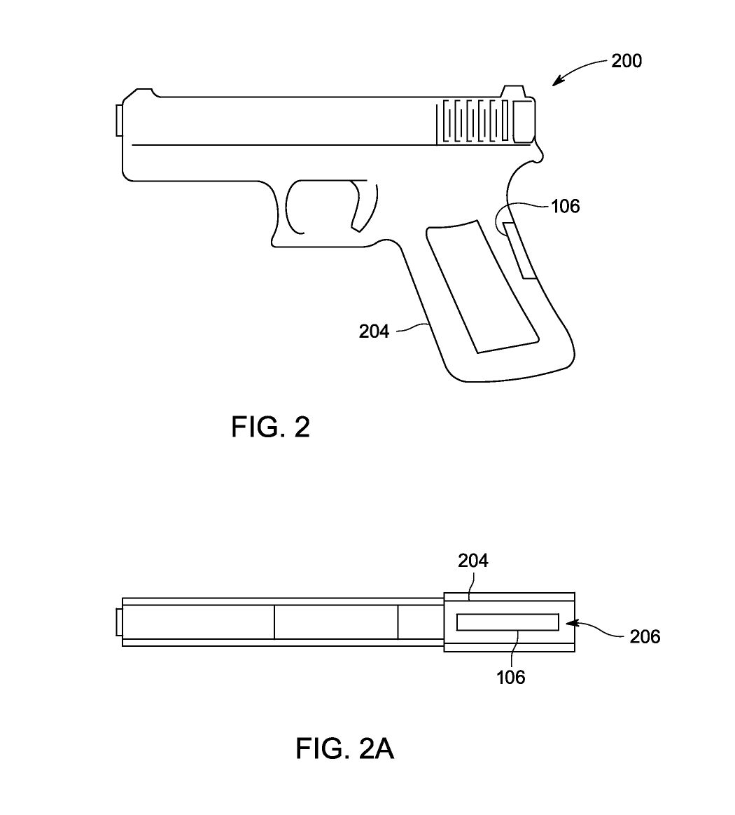

Referring to FIG. 2, the first tag 106 may be coupled to the firearm 200 at any location about the firearm that does not impede normal operation of the firearm 200. For example, in some embodiments, the first tag 106 may be coupled to the grip 204 of the firearm 200, as shown in FIG. 2, or a bottom 206 of the grip 204 (e.g., the butt of the firearm), as shown in FIG. 2A. Although a pistol is shown, the firearm 200 may be any type of firearm 200 for which tracking is desired. For example, in some embodiments, the firearm 200 may be a rifle, shotgun, assault rifle, carbine, or the like.

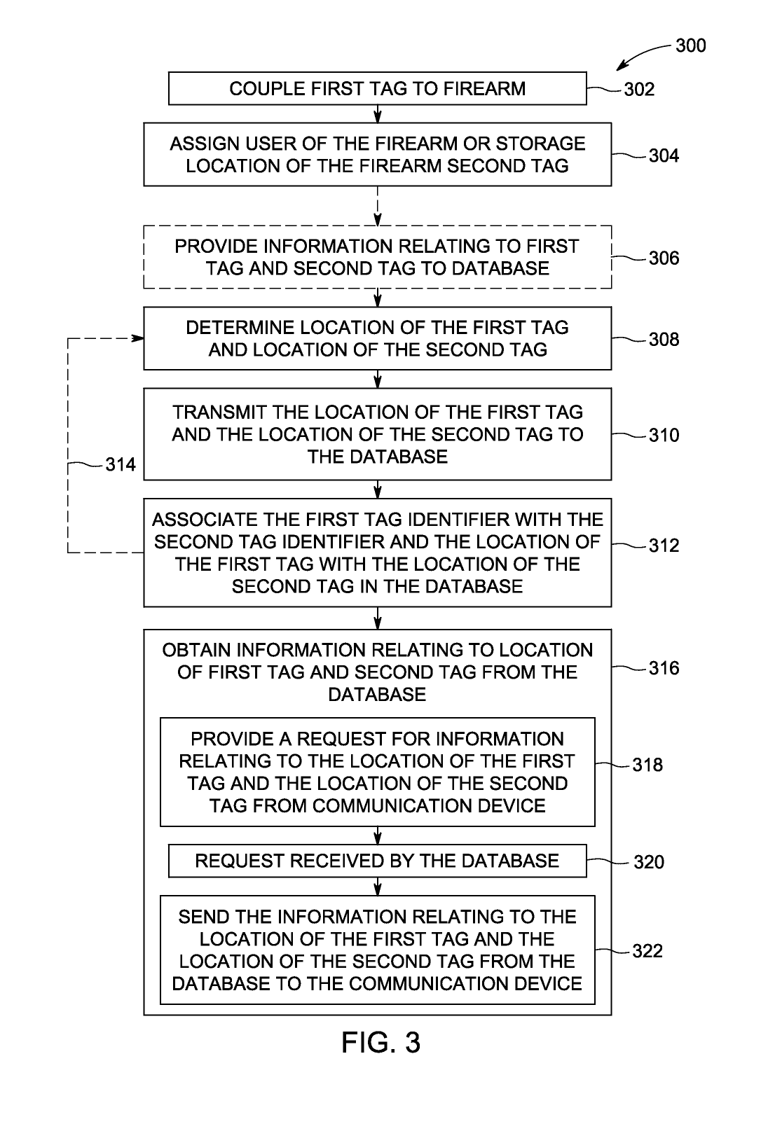

FIG. 3 depicts a method for tracking a firearm in accordance with some embodiments of the present invention. The method 300 generally begins at 302 where a first tag (e.g., the first tag 106 described above) is coupled to a firearm (e.g., the firearm 132 described above). The first tag may be coupled to the firearm via any manner suitable to provide secure coupling of the first tag to the firearm, for example, such as described above with respect to coupling the first tag 106 to the firearm 132.

Next, at 304, in some embodiments, a second tag (e.g., the second tag 114 described above) is assigned to a user (e.g., the user 134 of the firearm 132 described above) or coupled to a storage location of the firearm (e.g., the storage location 136 described above). In some embodiments, the second tag may be assigned to the user by storing information relating to the user on the second tag as part of a tag identifier, for example, such as the second tag identifier 118 described above. In embodiments where the second tag is coupled to a storage location of the firearm the second tag may be coupled to the storage location in any manner suitable to provide secure coupling of the second tag to the storage location, for example, such as described above with respect to coupling the second tag 114 to the storage location 136.

Next, at 306, in some embodiments, information relating to the first tag and the second tag may be optionally provided to a database. The database may be any database suitable to store and/or compile such information, for example, such as the database 122 described above. The information may be provided to the database via any suitable mechanism, for example, such as a transmission of the information from the first tag and the second tag via a network (e.g., network 104 described above) or reading the information from the first tag and the second tag via a scanner (e.g., the scanner 138 described above).

Next, at 308, in some embodiments, the location of each of the first tag and the second tag is determined. The location of the first tag and the second tag may be determined via any system suitable to determine the location of each of the first tag and the second tag, for example a GPS system utilizing one or more GPS transmitters, satellites, networks, or the like such as the first GPS transmitter 112, second GPS transmitter 120, GPS satellites 124 and AGPS network 126 described above.

Next, at 310, in some embodiments, the location of each of the first tag and the second tag is transmitted to the database. The location of each of the first tag and the second tag may be transmitted to the database via any suitable manner, for example, via the first GPS transmitter 112, second GPS transmitter 120, network 104, tracking station 102 described above.

Next at 312, the first tag identifier is associated with the second tag identifier and the location of the first tag is associated with the location of the second tag in the database. Associating the information in such a manner allows a user accessing the database to identify a location of each of the firearm (via the first tag) and the location of the associated firearm user or storage location.

In some embodiments, at least a portion of the method 300 may be repeated to facilitate continuous and/or real time monitoring of the firearm and user/storage location. For example, as indicated by the arrow 314, in some embodiments, determining the location of the first tag and the location of the second tag at 308, transmitting the location of the first tag and the second tag to the database at 310 and associating the first tag identifier with the second tag identifier and the first location with the second location at 312 may be repeated any number of times necessary to facilitate monitoring or tracking the firearm and user/location in a desired frequency.

Next at 316, information relating to the location of the first tag and the second tag may be obtained from the database. To obtain the location of the first tag and the second tag from the database, first, at 318 a request for information relating to the location of the first tag and the second tag may be provided from a communication device. The communication device (e.g., the communication device 128 described above) may be any type of device capable of accessing the database, for example, such as the described above with respect to the communication device 128.

The request may be transmitted to from communication device to the database via a network (e.g., internet network, wireless cellular network, or the like) for example, such as the network 104 described above. The request may be made by any user having access to the database (or having an access code to permit access to the database) for example, a law enforcement officer, facility (e.g., a gun range) operator, or a firearm owner. In some embodiments, the request may be accompanied by a unique access code (e.g., a password, pin number, or the like) provided to a user to allow a user to access the information contained within the database relating to a specific first tag and second tag.

The request may include any type of query for at least a portion of the total information relating to the location of the first tag and the second tag stored within the database. For example, in some embodiments, the request may contain a query for an instantaneous/real time location or past location of the first tag and/or second tag at a given time. In some embodiments, the request may contain a query for continued location information of the first tag and/or second tag during movement of the first tag and/or second tag. In some embodiments, the request may contain a query for an alert when the first tag and/or second tag travel outside of a predetermined location. In such embodiments, the predetermined location may be established via a virtual perimeter (e.g., as established by predetermined coordinates, a virtual fence or geo-fence, or the like), a facility, or a local network (e.g., the local area network 144 described above). In some embodiments, the request may be a query for an alert when the first tag is separated from the second tag at a predetermined distance.

Next, at 320, the request is received by the database. Following the receipt of the request, the information relating to the location of the first tag and the second tag is sent from the database to the communication device, at 322. The information relating to the location of the first tag and the second tag may be sent via a network (e.g., internet network, wireless cellular network, or the like) for example, such as the network 104 described above. Upon receipt of the information, the information may then be displayed to the user via, for example a display of the communication device such as the display 146 described above.

After the information relating to the location of the first tag and the second tag is sent to the communication device at 322, the method generally ends. In some embodiments, at least portions of the method 300 may be repeated to facilitate further requests for information, continuous monitoring further notifications, or the like.

Thus, embodiments of a system and method for tracking firearms have been provided herein. In at least some embodiments, the inventive system and method may advantageously provide location information with respect to a firearm and/or user of the firearm.

While the foregoing is directed to embodiments of the present invention, other and further embodiments of the invention may be devised without departing from the basic scope thereof.

1. A system for tracking a firearm, the system comprising:
a tracking station in communication with a network;
a first tag coupled to a firearm, the first tag comprising a first tag identifier and a first Global Positioning System (GPS) transmitter effective to communicate a location of the first tag to the tracking station over the network;
a second tag, assigned to a user of the firearm or a storage location of the firearm, the second tag comprising a second tag identifier and a second Global Positioning System (GPS) transmitter effective to communicate a location of the second tag to the tracking station over the network; and
a database in communication with the tracking station, the database effective to associate the first tag identifier with the second tag identifier and to associate the location of the first tag with the location of the second tag.

2. The system of claim 1, further comprising:
a communication device in communication with the database, the communication device configured to display information relating to the location of the first tag and the location of the second tag.

3. The system of claim 2, wherein the communication device is configured to send a request to the database requesting information regarding the location of the first tag.

4. The system of claim 2, wherein the communication device is one of a personal digital assistant, a computer, a mobile device, or a mobile phone.

5. The system of claim 2, wherein the communication device is configured to provide an alert when at least one of the first tag or the second tag travels outside of a predetermined area.

6. The system of claim 1, wherein the storage location is a container used to secure the firearm.

7. The system of claim 6, wherein the second tag is coupled to the container.

8. The system of claim 1, wherein the second tag is a GPS enabled mobile phone, mobile device, personal digital assistant (PDA) or computer.

9. The system of claim 1, wherein at least one of the first GPS transmitter or the second GPS transmitter comprises an Assisted Global Positioning System (AGPS) transmitter.

10. The system of claim 1, wherein the first tag is removably coupled to the firearm.

11. The system of claim 1, wherein the first tag is manufactured into the firearm.

12. The system of claim 1, further comprising:
a computer configured to receive the first tag identifier and second tag identifier and transmit the first tag identifier and second tag identifier to the database.

13. The system of claim 12, wherein the computer comprises a scanner configured to read the first tag identifier and second tag identifier and transmit the first tag identifier and second tag identifier to the computer.

14. The system of claim 1, wherein at least one of the first tag or the second tag comprises a local area transmitter effective to communicate a location of at least one of the first tag or the second tag to a local area network.

15. A method of tracking a firearm, comprising:
coupling a first tag to a firearm, the first tag comprising a first tag identifier and a first Global Positioning System (GPS) transmitter, the first Global Positioning System (GPS) transmitter effective to communicate a location of the first tag;
assigning a user of the firearm or a storage location of the firearm a second tag comprising a second tag identifier and a second GPS transmitter, the second GPS transmitter effective to communicate with a location of the second tag;
determining the location of the first tag and the location of the second tag using the respective first Global Positioning System (GPS) transmitter and the second Global Positioning System (GPS) transmitter; and
associating the first tag identifier with the second tag identifier and associating the location of the first tag with the location of the second tag in a database.

16. The method of claim 15, further comprising:
obtaining information regarding the location of the first tag and the location of the second tag from the database by;
providing a request for information regarding the location of the first tag and the location of the second tag from a communication device to the database over a network;
receiving the request by the database; and
sending the information regarding the location of the first tag and the location of the second tag from the database to the communication device.

17. The method of claim 16, wherein providing the request comprises requesting an alert when at least one of the first tag or the second tag travels outside of a predetermined location.

18. The method of claim 15, further comprising:
assigning a database user an access code for access to the database.

19. The method of claim 15, wherein coupling the first tag to the firearm comprises manufacturing the first tag into the firearm.

20. The method of claim 15, wherein at least one of the first tag or the second tag comprises a local area transmitter effective to communicate a location of at least one of the first tag or the second tag to a local area network.
